(19) United States
(12) Patent Application Publication
(10) Pub. No.: US 2011/0254246 A1
(43) Pub. Date: Oct. 20, 2011

(54) BICYCLE SEAT HEIGHT AND ALIGNMENT DEVICE

(75) Inventor: Michael Pryde, Hong Kong (CN)

(73) Assignee: NEIL PRYDE LIMITED, Tuen Mun (HK)

(21) Appl. No.: 12/870,965

(22) Filed: Aug. 30, 2010

(30) Foreign Application Priority Data
Apr. 14, 2010 (HK) 10103668.3

(51) Int. Cl. B62K 19/36

(52) U.S. Cl. 280/287

(57) ABSTRACT

A bicycle seat height and alignment device has a first collar for affixing on the top of a bicycle seat tube of a bicycle frame and a second collar for affixing on a bicycle seat post to which a bicycle seat is affixed. The collars each have a complementary circumferentially extending abutting face. The faces are abuttable in only one possible orientation so as to align a bicycle seat affixed to the seat post with the bicycle frame when the seat post is located on the seat tube such that the collars are contiguous.

### FIELD OF THE INVENTION

The current invention relates to bicycles generally and more particularly to a device for quickly setting the height and alignment of a bicycle seat.

### BACKGROUND TO THE INVENTION

When cycling it is highly advantageous to have the correct seat height and alignment in order to improve cycling efficiency and also to avoid strains and injuries particularly involving the knees. As is well-known in the art a bicycle seat is attached to the top of a seat post (pillar) that is telescopically received within the top portion of the bicycle frame seat tube. A clamping device in the form of a penannular collar is located at the top of the seat tube for firmly clamping the seat post to secure both the seat height and alignment.

On modern bicycles the seat clamp generally comprises a quick release mechanism so that the seat height can be quickly changed and/or the seat removed from the bicycle frame. It is common practice to remove the bicycle seat from the frame for security reasons when a bicycle is being left in a public place and also when the bicycle is being transported such as in a bicycle bag.

While it is quick to remove a bicycle seat it often takes some time to reposition the seat back in exactly the right place so that the height and alignment are suited to the rider. It has long been known to associate something with the seat post to mark the desired return height. Various known solutions include a taped marker, a plastic cable type, a permanent marker, a piece of string, a scribbled line or an elastic band located around the seat post. While such means help indicate the correct return height of the seat a problem still exists in that such means can sometimes be dislodged or displaced and they do not help with returning the seat to the correct riding alignment.

### SUMMARY OF THE INVENTION

It is an object of the present invention to provide a seat height and alignment device, which overcomes or at least ameliorates the above-mentioned problems.

Accordingly, there is provided a bicycle seat height and alignment device as herein defined in any one of the appended claims.

Further aspects of the invention will become apparent from the following description, which is given by way of example only to illustrate the invention.

### A BRIEF DESCRIPTION OF THE DRAWINGS

The invention will now be described with reference to the attached drawings in which:

FIGS. 1A and 1B illustrate a first exemplary embodiment of a seat height and alignment device according to the invention,

FIGS. 2A and 2B illustrate a second exemplary embodiment of a seat height and alignment device according to the invention,

FIG. 3 is a cross section through the device of the second embodiment,

FIG. 4 is a cross section through the device of the second embodiment with the two collars contiguously located, and

FIG. 5 illustrate a third exemplary embodiment of a seat height and alignment device according to the invention.

### DESCRIPTION OF THE PREFERRED EMBODIMENT

Before any embodiments of the invention are described in detail, it is to be understood that the invention is not limited in its application to the details of arrangements set forth in the following description or illustrated in the accompanying drawings. The invention is capable of other embodiments and of being practiced or of being carried out in various ways. Also, it is to be understood that the phraseology and terminology used herein are for the purpose of description and should not be regarded as limiting.

As is generally known in the art a bicycle frame typically, although not essentially, consists of a head tube, a down tube extending from the head tube to a bottom bracket shell, a top tube extending substantially horizontally from the head tube to the top part of a seat tube that extends substantially vertically from the top tube to the bottom bracket shell to form the first, main, triangle of the frame geometry. A pair of seat stays extends from the seat tube downwardly to a pair of drop-outs to which the rear axial of a rear wheel of the bicycle can be engaged. A pair of chain stays extends from the pair of drop-outs to the bottom bracket shell forming a second triangle of the frame geometry. A front fork extends from the head tube to a pair of front wheel drop-outs to which the from wheel axel attaches. A handlebar cooperates with the head tube and fork for steering and controlling the bicycle. A seat is attached to the top of a seat post which telescopically engages with an upper hollow part of the seat tube and is clamped therein. The seat post can be telescopically moved within the seat tube for adjusting the seat height.

A bicycle seat height and alignment device according to one embodiment of the present invention has a first collar for affixing with the hollow top part of a bicycle seat tube of the bicycle frame and a second collar for affixing with a bicycle seat post to which a bicycle seat is affixed. The collars each have a complimentary circumferentially extending abutting face. In the preferred embodiment the complimentary faces of the collars abut in only one possible orientation so as to align a bicycle seat affixed to the seat post with the bicycle frame when the seat post is located with the seat tube such that the collars are contiguous. The second collar is affixed to the seat post at a location consistent with a correct riding seat height of a person using the bicycle and in the correct rotational orientation on the seat post so that the seat height and rotational orientation are consistently and quickly set each time the seat post is located with the seat tube. The first collar for affixing with the top of the bicycle seat tube can also function as a seat post clamp having releasable fastening means of a type known in the art for firmly holding the seat post in position with the seat tube. In an alternative embodiment of the invention, the complimentary faces of the collars abut in only one of two possible orientations that are rotationally 180-degrees apart.

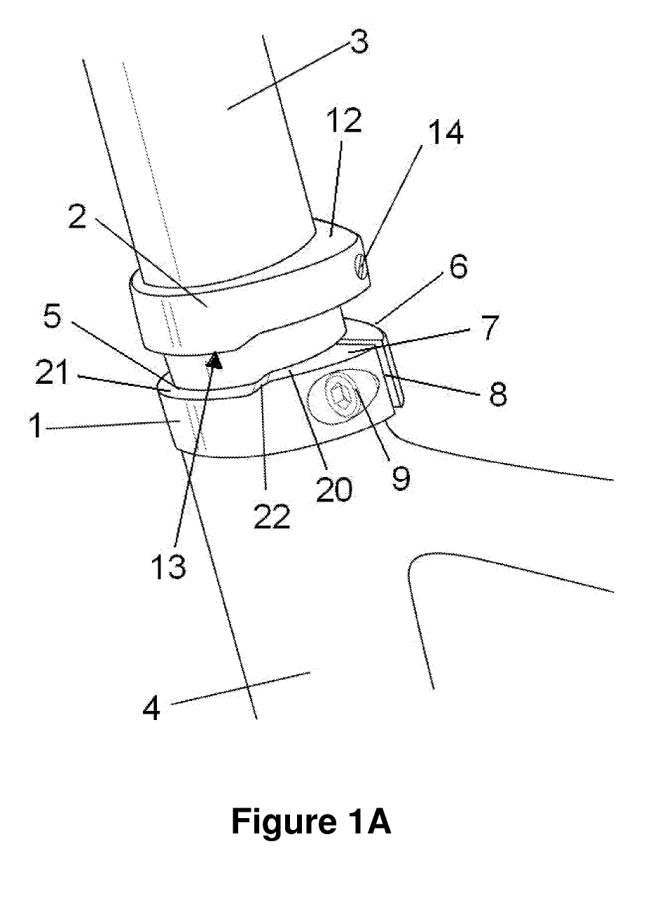

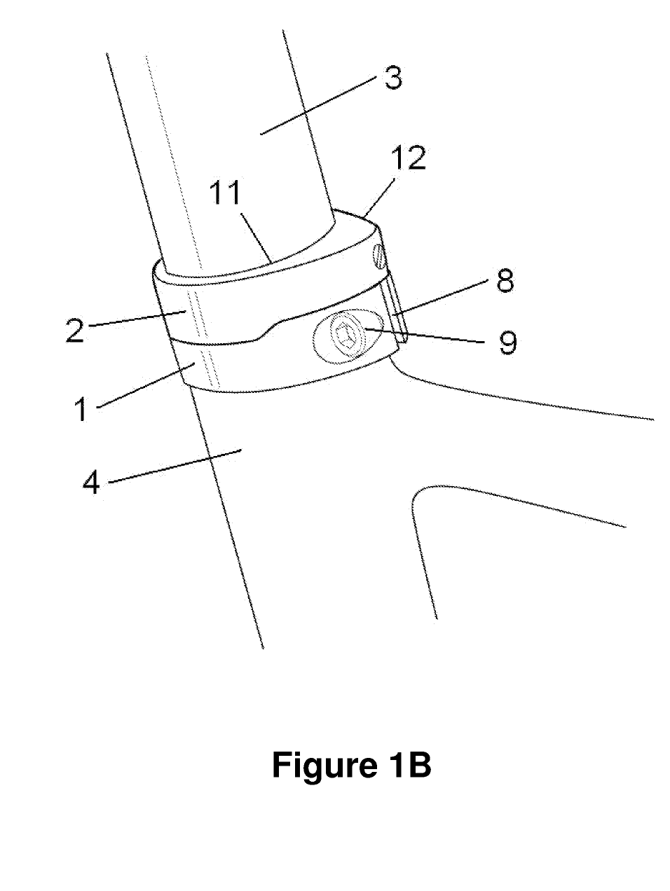

Referring to the drawings there is shown exemplary embodiments of a bicycle seat height and alignment device according to the invention. The device comprises two separate collars 1, 2 for affixing to the seat post 3 and seat tube 4 of a bicycle respectively. When the seat post 3 is located within the seat tube 4 for affixing the seat (not shown) to the bicycle frame the two collars 1, 2 can be brought into a contiguous relationship illustrated by FIGS. 1B, 2B and 4 to set the correct seat height and rotational alignment of the seat quickly and repeatably.

The first collar 1 is adapted to affix to the top of a bicycle seat tube 4. The collar 1 has a circular inner perimeter 5 through which the seat post 3 can pass into the seat tube 4, and an ovoid, or egg shaped, outer perimeter 6 although this is not essential to the invention as will be described later. Between the inner and outer perimeters 5, 6 is a first circumferentially extending abutting face 7. In the preferred embodiment the first collar 1 is penannular having a small gap 8 in the wall of the collar. A fastener 9 is provided in the collar to allow the gap 8 to be progressively closed to provide a clamping force at the inner perimeter 5 of the first collar 1. The first collar 1 also serves as a seat post clamp to clamp the bicycle seat post 3 firmly with the seat tube 4.

The second collar 4 is an annulet for affixing about the bicycle seat post 3. The second collar 2 has inner and outer perimeters 11, 12 that are complimentary to the inner and outer perimeters 5, 6 of the first collar 1. Between the inner and outer perimeters 11, 12 of the second collar 2 is a second circumferentially extending abutting face 13, which is complimentary with the first circumferentially extending abutting face 7 of the first collar so that the two faces 7, 13 can abut. The second collar 2 has a fastener in the manner of a blind set-screw 14 (also known as a grub screw) for fixedly locating the second collar 2 with the seat post 3.

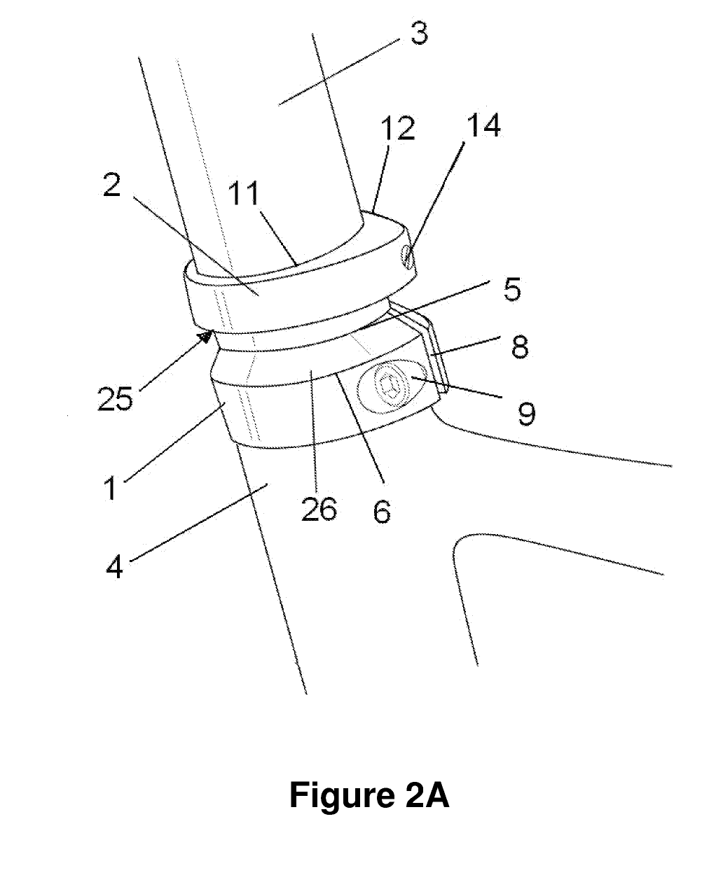

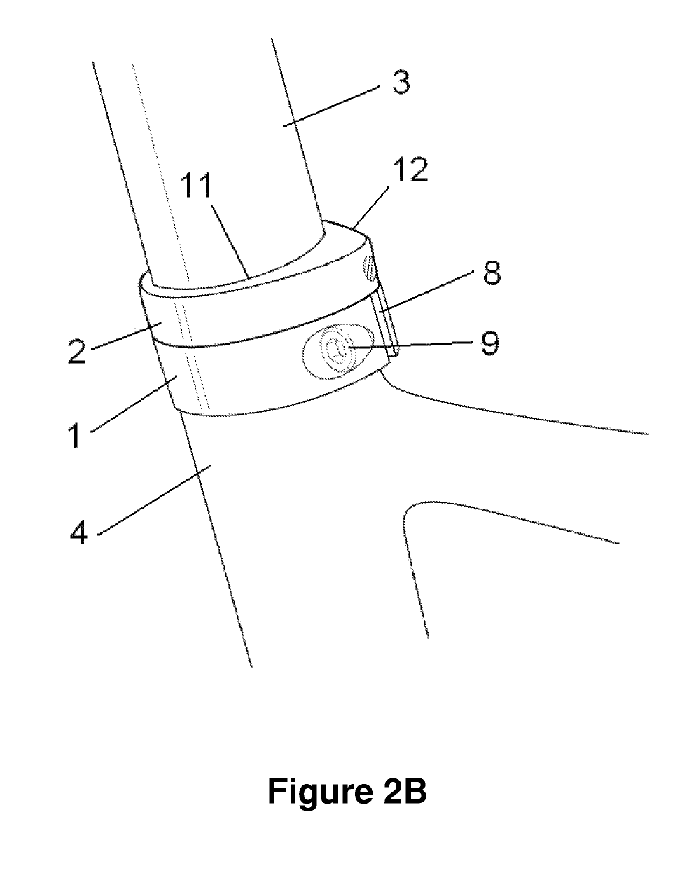

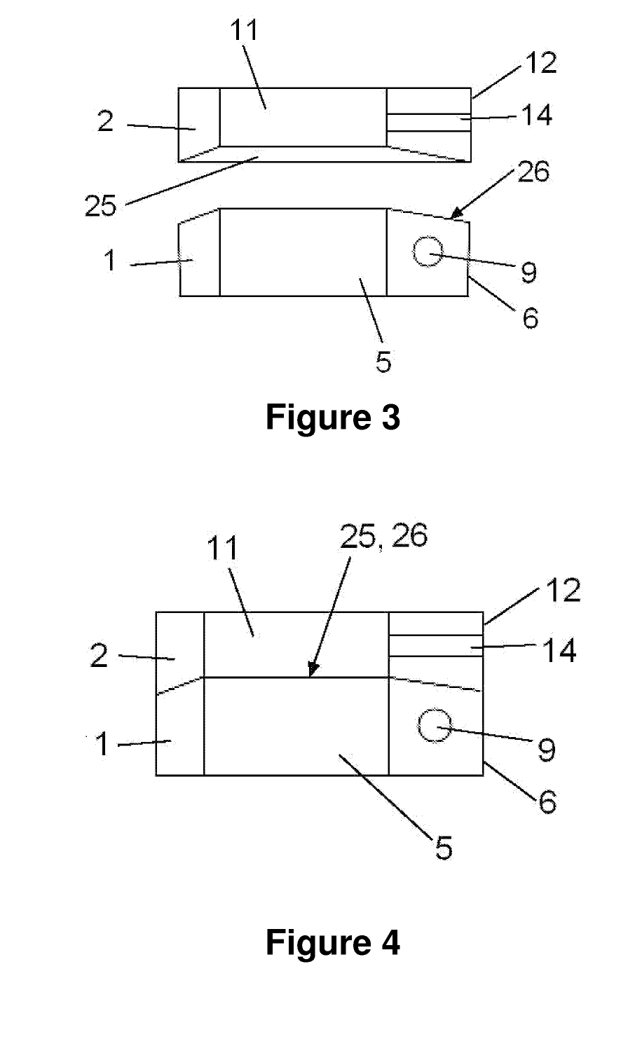

In preferred embodiments of the invention that two circumferentially extending abutting face 7, 13 are adapted so that when the collars are brought in to a contiguous relationship as shown in FIGS. 1B, 2B and 4 the two faces 7, 13 abut in only one possible orientation so that the seat post, and thus the seat affixed thereto, can be correctly aligned with the bicycle frame by the abutting of the two complimentary faces 7, 13. The longitudinal location of the second collar 2 on the seat post 3 also sets that correct seat height by the abutting of the two complimentary faces 7, 13. FIGS. 1A and 1B illustrate a first example of how the two complimentary faces 7, 13 are adapted to abut in only one possible orientation. The faces 7 have complimentary first portions 20 and second portions 21, which are non-coplanar and joined by a third ramp portion 22. In these way the two faces 7, 13 only abut when the two collars are in a one possible orientation so that the complimentary non-coplanar surfaces align. FIGS. 2A, 2B, 3 and 4 illustrate a second example of how the two complimentary faces are adapted to abut in only one possible orientation. The two faces 25, 26 have a complimentary bevel between the inner and outer perimeters of the collars 1, 2. Because the inner perimeters are circular and the outer perimeters are non-circular the two beveled faces 25, 26 will only abut when the two collars are in a one possible orientation.

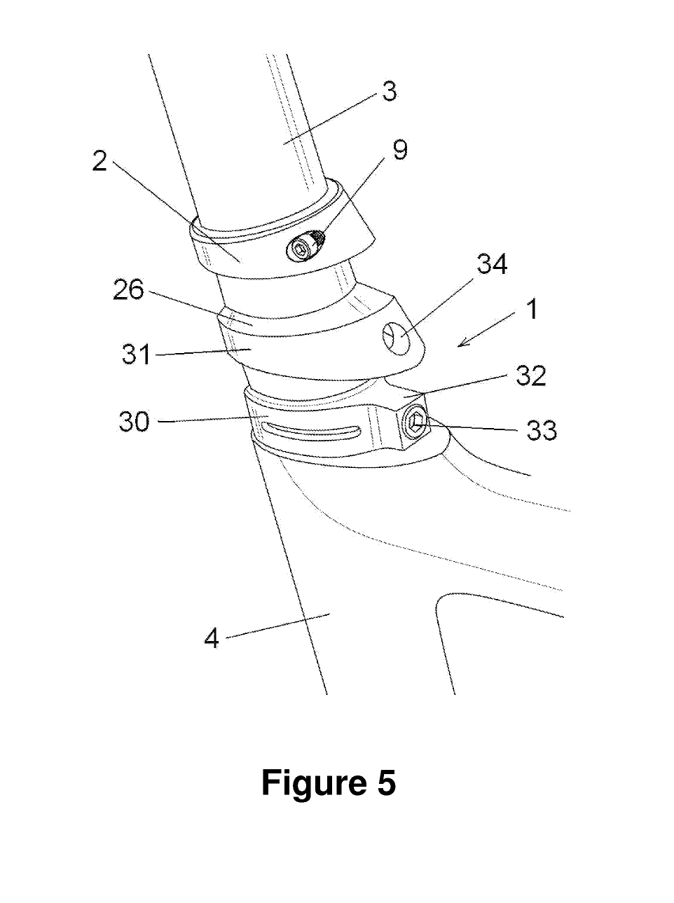

FIG. 5 illustrates an alternative embodiment of the invention in which the first collar 1 has an annulet 30 about the top of the seat tube 4 covered by a semi rigid sleeve or boot 31. The boot is made from rubber or similar material and includes the circumferentially extending abutting face 26 of the first collar 1. The annulet 30 has a boss 32 with a threaded hole through which a blind set-screw 33 is inserted. The set-screw 33 is driven by a hex, or other, key or driver and is tightened to exert compression or clamping force on the seat post 3 to prevent relative motion between the post 3 and seat tube 4 once the seat post is in the correct position. A hole 34 is provided in the front of the boot 31 to facilitate access of a hex-key to tighten the set-screw 33.

Although two examples of how the two complimentary faces are adapted to abut in only one possible orientation are given these are not intended to limit the scope or functionality of the invention. It will be appreciated that other adaptations can be used to permit the two complimentary faces to abut in only one possible orientation. For example, the two faces may comprise complementary ramps. The collars are coaxial or concentric with at least the seat post in use and so ramp faces will only abut when the two collars are in only one possible orientation. The skilled addressee will also appreciate that in the example of FIGS. 1A and 1B or in the case of ramp faces the outer periphery need not necessarily have a non-circular shape for abutting of the faces in only one possible orientation. However, in the illustrated examples the non-circular shape also provides thickness on one side of the collar for the fasteners 9, 14. The skilled addressee with appreciate that suitable results will also be achieved if the complimentary faces of the collars abut in only two possible orientations, one of which is rotationally offset 180-degrees with respect to the other. Such a result can be achieved in some embodiments of the invention by, for example, providing the complementary abutting faces with symmetry about a longitudinal axis, lateral axis or both (e.g. quadrants) so that they may abut in 180-degree opposed orientations.

In the illustrated examples the first collar 1 is also a seat post clamp. This is not essential to the invention. The skilled addressee with appreciate that the first collar can also be an annulet for locating with an existing seat post clamp, or the first collar can be integrally formed with the top of the seat tube 4. The first collar can be affixed to the top of the seat tube 4 by welding, in the case of alloy or metallic frames, or by other means known in the art.

1. A bicycle seat height and alignment device comprising:
a first collar for location on a bicycle seat tube, the first collar having a first circumferentially extending abutting face, and
a second collar for location on a bicycle seat post, the second collar having a second circumferentially extending abutting face complementary to the first circumferentially extending abutting face, the first and second circumferentially extending abutting faces being abuttable in only first and second orientations, the first orientation being 180-degrees offset with respect to the second orientation.

2. (canceled)

3. The device of claim 1 wherein the first and second complementary abutting faces comprise non-coplanar surfaces.

4. The device of claim 16 wherein the complementary abutting faces comprise asymmetrical abutting faces.

5. The device of claim 1 wherein the first and second collars each have a circular inner circumferential perimeter for receiving the bicycle seat post through the respective collar and a non-circular outer circumferential perimeter, and the respective circumferentially extending abutting face is located between the respective inner and outer circumferential perimeters.

6. The device of claim 1 wherein the respective external perimeters are one of ellipsoid and ovoid.

7. The device of claim 1 wherein the first collar comprises a penannular ring and a releasable fastener for closing the penannular ring about a bicycle seat post to clamp the bicycle seat post within the second collar.

8. The device of claim 1 wherein the first collar includes a sleeve locatable over the first collar, the sleeve comprising the first circumferentially extending abutting face.

9. The device of claim 8 wherein the sleeve is a semi-rigid material.

10. The device of claim 9 wherein the semi-rigid material is one of rubber and a plastic.

11. The device of claim 1 wherein the second collar comprises an annulet for encircling the bicycle seat post and a second fastener for fixedly securing the annulet to the bicycle seat post.

12. The device of claim 1 wherein the complementary abutting faces compromise complementarily beveled faces.

13. The device of claim 1 wherein the complementary abutting faces comprise ramped faces.

14-15. (canceled)

16. A bicycle seat height and alignment device comprising:
a first collar for location on a bicycle seat tube, the first collar having a first circumferentially extending abutting face, and
a second collar for location on a bicycle seat post, the second collar having a second circumferentially extending abutting face complementary to the first circumferentially extending abutting face, the first and second circumferentially extending abutting faces being abuttable in only a single orientation.

17. The device of claim 16 wherein the first and second complementary abutting faces comprise non-coplanar surfaces.

18. The device of claim 16 wherein the first and second collars each have a circular inner circumferential perimeter for receiving the bicycle seat post through the respective collar and a non-circular outer circumferential perimeter, and the respective circumferentially extending abutting face is located between the respective inner and outer circumferential perimeters.

19. The device of claim 16 wherein the first collar comprises a penannular ring and a releasable fastener for closing the penannular ring about a bicycle seat post to clamp the bicycle seat post within the second collar.

20. The device of claim 16 wherein the first collar includes a sleeve locatable over the first collar, the sleeve comprising the first circumferentially extending abutting face.

21. The device of claim 16 wherein the second collar comprises an annulet for encircling the bicycle seat post and a second fastener for fixedly securing the annulet to the bicycle seat post.

22. The device of claim 16 wherein the complementary abutting faces comprise complementarily beveled faces.

23. The device of claim 16 wherein the complementary abutting faces comprise ramped faces.
